(19) United States
(12) Patent Application Publication
(10) Pub. No.: US 2019/0084254 A1
(43) Pub. Date: Mar. 21, 2019

(54) FIBER COMPOSITE COMPONENT AND PRODUCTION METHOD

(71) Applicant: SCHUNK KOHLENSTOFFTECHNIK GMBH, Heuchelheim (DE)

(72) Inventors: Roland Weiss, Huettenberg (DE); Martin Henrich, Wetzlar (DE); Rudolf Weck, Sinn (DE); Marco Ebert, Biebertal (DE); Fabian Koester, Giessen (DE); Thorsten Scheibel, Bad Nauheim (DE); Bastian Behrens, Garching (DE); Raphael Setz, Riedmoos (DE)

(21) Appl. No.: 16/082,420

(22) PCT Filed: Feb. 24, 2017
(86) PCT No.: PCT/EP2017/054394

§ 371 Date: Sep. 5, 2018

(30) Foreign Application Priority Data
Mar. 18, 2016 (DE) 10 2016 105 129.2
Mar. 24, 2016 (DE) 10 2016 205 014.1

(51) Int. Cl. B29C 70/76; B29C 70/86; B29C 70/20

(52) U.S. Cl. CPC B29C 70/763; B29L 2031/448; B29C 70/20; B29C 70/86

(57) ABSTRACT

The invention relates to a fiber composite component (17) and to a method for producing a fiber composite component (17), for an aircraft, in particular for an aircraft cabin interior, a tabletop (21) or the like, the fiber composite component (17) being formed from a matrix composite material (19) and a support structure, wherein the matrix composite material (19) is formed from cut fibers, a curable resin, and a flame retardant, the support structure being formed from a dimensionally stable fiber composite (18) and/or a metal profile, the matrix composite material (19) together with the support structure being introduced into a component mold and cured to form the fiber composite component (17), the support structure being at least partially bonded with the matrix composite material (19).

The invention relates to a fiber composite component and to a method for producing a fiber composite component for an aircraft, in particular for an aircraft cabin interior, a tabletop or the like, the fiber composite component being formed from a matrix composite material and a support structure.

Fiber composite components are frequently used in aircraft construction, where it is known for matrix composite materials that are composed of cut fibers, such as glass fibers, a cross-linkable resin and fillers, to be provided with a support structure. The support structure can be an aluminum plate, for example, which is glued to a cured matrix composite material, which is also plate-shaped in this case, to form the fiber composite component. Fiber composite components of this kind can also have cavities or recesses in order to reduce the weight of the fiber composite component. Hence, fiber composite components are frequently used to substitute aluminum components with the objective of reducing weight.

In the case of fiber composite components of an aircraft cabin interior, in particular, there are high standards in terms of flammability and combustibility, which is why flame retardants are typically added to the matrix composite materials used there. However, these flame retardants have the disadvantage that the strength of the fiber composite component is substantially reduced by the addition of the flame retardant. Hence, matrix composite materials containing flame retardants are only used for components that do not have to meet high strength requirements. Production of matrix composite materials that are reinforced by a support structure or shielded against fire, on the other hand, is complicated because the support structure has to be connected to the component made of the matrix composite material by gluing, for example. Oftentimes, a multitude of process steps are required which are economical only when executed manually because of the mode of installation of the component and of the support structure.

Furthermore, it is known for phenolic resin to be used as a material for the matrix of a fiber composite material. Phenolic resin has the advantage that it reaches fire-retardant properties that are demanded by aviation authorities. The disadvantage, however, is that phenolic resin presents a health hazard in particular during processing of the liquid phenolic resin and during machining and poses a risk to the workers at the production site. This requires an enormous amount of additional measures for health protection and work safety.

Therefore, the object of the invention is to propose a method for producing a fiber composite component and to propose a fiber composite component that allows cost-effective production while exhibiting high strength.

This object is attained by a method having the features of claim 1, by a fiber composite component having the features of claim 16, and by a use of a matrix composite material having a support structure according to the features of claim 18.

In the method according to the invention for producing a fiber composite component for an aircraft, in particular for an aircraft cabin interior, a tabletop or the like, the fiber composite component is formed from a matrix composite material and a support structure, wherein the matrix composite material is formed from cut fibers, a curable resin, and a flame retardant, the support structure being formed from of a dimensionally stable fiber composite and/or a metal profile, the matrix composite material together with the support structure being introduced into a component mold and cured with the fiber composite component, the support structure being at least partially bonded with the matrix composite material.

Accordingly, the flame retardant is added to the matrix composite material made of the cut fibers and the curable resin, making the matrix composite material suitable for use as a component of an aircraft cabin interior owing to thus severely reduced flammability. The support structure is formed from a dimensionally stable fiber composite and/or from a metal profile. The dimensionally stable fiber composite, in particular, can be formed in such a manner that it is combustible or easily inflammable. This allows the dimensionally stable fiber composite to be provided with high strength. In the course of the method, it is envisaged that the dimensionally stable fiber composite is introduced into a component mold of the fiber composite component and to be connected to the matrix composite material in the component mold. Hence, the matrix composite material is not cured before it is placed in the component mold, the matrix composite material bonding with the dimensionally stable fiber composite during curing. Consequently, the dimensionally stable fiber composite has to be at least partially covered by the matrix composite material. The same applies to a metal profile if it forms the support structure. The dimensionally stable fiber composite, at least, becomes flame-retardant or slow-burning. At the same time, the dimensionally stable fiber composite stabilizes the matrix composite material, which substantially forms an outer shape of the fiber composite component. The dimensionally stable fiber composite can also be replaced with the metal profile or with a plurality of metal profiles, which then are also bonded with the matrix composite material. Overall, slow-burning or flame-retardant light fiber composite components become cost-effectively producible in this way because the method of connecting the support structure and the matrix composite material in the component mold can be executed in an automated fashion. The curable resin can be selected such that the fiber composite component can be produced from thermoset or thermoplastic materials.

The fiber composite can be formed from textile fibers and/or unidirectional fibers. The textile fibers can be a fiber tissue, for example, which can already be present in the form of a pre-preg. Furthermore, the textile fibers can be a fiber mesh or a fiber strand. The fibers of the fiber composite can at least partially be disposed unidirectionally.

The fiber composite can be formed as a spatially oriented support structure of the fiber composite component and the support structure can be adapted to a load condition of the fiber composite component. Accordingly, the fiber composite can be disposed in or on the fiber composite component in such a manner that a load condition depending on the use of the fiber composite component can be accommodated in such a manner that a large part of the forces acting on the fiber composite component are introduced into the fiber composite. In this way, matrix composite material can be saved and the weight of the fiber composite component can be reduced. The fiber composite can be made of different organic or inorganic fibers. For example, carbon fibers, glass fibers, aramid fibers, basalt fibers, oxide fibers, and metal fibers can be used as fibers both in textile form and unidirectionally. In this way, the support structure can be optimized for or tailored to the required load condition both mechanically and in terms of lightweight construction.

Also, machining of the fiber composite can be avoided by using the matrix composite material in combination with the fiber composite. At least for the fiber composite, fiber composite materials that have a phenolic resin matrix can be used in order to comply with the fire-resistant properties demanded in the aviation industry, for example. In this way, production work is significantly reduced. In particular, additional measures for work safety and health precautions are avoided, which leads to significant cost savings. The method is well suited for series production while being flexibly applicable, allowing different aircraft components to be produced in quick succession.

Advantageously, the fiber composite can be formed from carbon fibers, wherein the carbon fibers can be coated with pyrolytic carbon so as to form the fiber composite. Carbon fibers have high strength and can be connected to one another by being coated with the pyrolytic carbon, leading to the formation of the dimensionally stable fiber composite or of what is referred to as a preform made of carbon fibers. Accordingly, the fiber composite can be made of CFC. Moreover, stability of the carbon fibers or of the preform is substantially increased by the pyrolytic carbon. The carbon fibers can also be completely surrounded with the pyrolytic carbon in such a manner that the carbon fibers are connected to each other at their respective mutual contact points by means of the coating of pyrolytic carbon. Since the carbon fibers can be coated with a relatively thin layer of pyrolytic carbon, a space that can be filled with the matrix composite material will remain between the carbon fibers, allowing a particularly tight connection to be formed between the support structure and the matrix composite material. A fiber composite component reinforced in this way will exhibit improved mechanical strength, also with respect to a comparable component weight, compared to a conventional fiber composite component having cut fibers.

In the course of the method, the pyrolytic carbon can be deposited onto the carbon fibers from the vapor phase. In this way, it becomes possible for the carbon fibers to be coated with a relatively thin layer of pyrolytic carbon and to be simultaneously fixed in a dimensionally stable manner. Furthermore, a layer thickness can be adjusted as needed in a particularly simple manner when coating from the vapor phase. It is also possible to produce fiber composites having nearly any type of geometry because the respective gas can easily permeate the fiber composite. Preferably, the pyrolytic carbon can be formed as a deposit produced on the carbon fibers by means of a CVD method or a CVI method. In an alternative version of the method, the pyrolytic carbon coating can be formed on the carbon fibers by pyrolysis of a thin resin or pitch layer on the carbon fibers.

Furthermore, the cut fibers can be carbon fibers. The cut fibers can have a fiber length of 20 to 50 mm and also be coated with pyrolytic carbon. If the cut fibers do not have a specific spatial orientation, it becomes possible to fill the matrix composite material into the component mold as a pasty mass. Alternatively, it is also possible for the cut fibers to be glass fibers or any other suitable type of organic or inorganic fibers.

The fiber composite component can be configured in such a manner that it has a carbon fiber content of >50% by volume. This is particularly advantageous if, according to the intended use of the fiber composite component, a higher content of carbon fibers has a particularly favorable effect on its properties. Also, in this case, the fiber composite component can be formed especially easily in relation to the volume.

The fiber composite component can also be configured in such a manner that the carbon fibers are heterogeneously distributed within the fiber composite component. This means that sections of the composite component can have a higher or lower content of carbon fibers. The dimensionally stable fiber composite allows the content of carbon fibers within the fiber composite component and the spatial orientation of the carbon fibers to be specifically set and predetermined so as to influence the mechanical properties of the fiber composite component. The cut fibers of the matrix composite material can be homogenously distributed on their own.

The matrix composite material can be a semi-finished fiber matrix product, in particular a sheet molding compound (SMC) or a bulk molding compound (BMC). The semi-finished fiber matrix product can also be present as a plate-shaped dough-like molding material made of thermosetting reaction resins and cut fibers. All components of the matrix composite material can be fully pre-mixed and ready for processing. Preferably, an SMC-LP (SMC low profile) having reduced shrinkage and high surface quality can be used because this may allow further processing of a surface of the fiber composite component or finishing thereof to be entirely omitted. This semi-finished fiber matrix product can be processed in a particularly simple manner by hot pressing in the component mold.

The matrix composite material can be compressed with the support structure in the component mold at a pressure of 80 bar and 150 bar, in particular between 90 bar and 110 bar, and at a temperature between 125° C. and 150° C., in particular between 130° C. and 140° C.

Preferably, it may be envisaged that at least the matrix composite material or the SMC material is fire-resistant according to EASA CS-25.853, version of Oct. 17, 2003. In particular, both the SMC material and the support structure can each be fire-resistant according to the aforementioned standard.

Standard CS-25.853, issued by the European Aviation Safety Agency EASA, defines the properties that an aircraft interior component has to have in order to be allowed to be used in commercial aviation. The standard prescribes a standardized test, which is explained in Appendix F, Part 1 of the set of standards CS-25. In particular, a test specimen has to have the dimensions 300 mm×75 mm×[thickness of the working surface]. In the test, the test specimen is placed under a Bunsen burner and exposed to a flame for 60 seconds. The following criteria have to be met:
The burn length (burnt length) of the specimen may not exceed 15 cm (6 inches);
The flame ignited on the specimen has to die on its own within 15 seconds;
Burning material must not drip from the specimen for more than 3 seconds.

Aside from the tests regarding fire resistance, standard CS-25.853 demands additional tests regarding the release of heat, smoke density and toxicity. Details can be taken from the aforementioned standard, version of Oct. 17, 2003. The flame retardant can be aluminum hydroxide. While this flame retardant disadvantageously lowers the strength of the matrix composite material, it substantially improves the fire-retardant properties. Aluminum hydroxide can also be added to the matrix composite material particularly easily as powder.

The matrix composite material can have a polymer matrix that comprises a powder made of aluminum trihydroxide. Aluminum trihydroxide is a particularly fire-resistant and fire-retardant component and increases the fire-resistant properties of the material. Thus, the fire-resistant properties demanded by aviation authorities are achieved.

In particular, the required fire-resistant properties can be achieved if the matrix composite material contains at least 40 w %, in particular at least 50 w %, in particular at least 60 w %, in particular at least 70 w % aluminum trihydroxide.

Furthermore, the fiber composite can be disposed in a premold and be pre-stabilized, preferably pre-cured, by pressing. In doing so, the fiber composite is also pre-compacted, whereby a stability of the fiber composite component is even further increased. Additives may also be added to the fiber composite during pressing in the premold, said additives making the fiber composite or rather the respective fibers adhere to one another, thus preliminarily fixing them.

The support structure can be introduced into the component mold in such a manner that the matrix composite material completely surrounds the support structure. This allows the support structure to also be completely protected or shielded against flame impact by the matrix composite material. Optionally, the support structure can also be disposed in the component mold in such a manner that only sections of the support structure are completely surrounded by the matrix composite material. Sections of the support structure not connected to the matrix composite material can be severed by mechanical processing after removal from the component mold. However, this is not necessarily required because these sections of the support structure can also be used for installation of the fiber composite component and for connecting it to other components.

A matrix of the support structure or of the fiber composite can also contain phenolic resin. The phenolic resin is characterized by good fire-resistant properties and, in this regard, fulfills the criteria required by aviation authorities for aircraft interior components. Since the support structure as a pre-fabricated element is completely enveloped by the matrix composite material by compression, a fiber composite material containing phenolic resin can be processed without health risks. The finished component does not pose a health hazard, either, because the support structure, which may contain phenolic resin, is completely enveloped. The matrix composite material can be free of phenolic resin.

In general, it may be envisaged that the support structure is produced in one piece or in multiple pieces. Producing the support structure in one piece is advantageous for high mechanical stability. However, depending on the geometry of the support structure, production in one piece may be complex and therefore economically unattractive. Hence, in the case of more complex geometries, production of the support structure in multiple pieces is suitable, the individual parts of the support structure preferably being connected to each other prior to placement in the component mold. This may take place by gluing, for example. In particular, a permanent connection between the individual parts of the support structure is not required. Pre-fixing that ensures contact of the parts of the support structure during compression is sufficient. The final linking and connecting of the parts of the support structure happens by way of the compression and by bonded coupling by means of the matrix composite material.

At least in sections, the support structure can form a frame that limits a frame inner surface. The frame inner surface can be filled with SMC material or matrix composite material. For instance, it may be envisaged that surface portions between two parts or sections of the support structure become filled with the SMC material in a planar manner. In the case of an aircraft table, for example, it may be sufficient to only reinforce edge portions of the planar component structure using the support structure. Planar portions of the component that will not be subjected to high mechanical loads can be formed solely by the SMC material.

The fiber composite component according to the invention for an aircraft, in particular for an air craft cabin interior, a tabletop or the like, is made of a matrix composite material and a support structure, the matrix composite material being made from cut fibers, a resin, and a flame retardant, the support structure being made of a dimensionally stable fiber composite and/or a metal profile, the matrix composite material together with the support structure having been introduced into a component mold and cured to form the fiber composite component, the support structure being at least partially bonded with the matrix composite material. Regarding the advantageous effects of the fiber composite component according to the invention, reference is made to the description of advantages of the method according to the invention.

The fiber composite component can be used for an aircraft cabin interior in a particularly advantageous manner if it has a density of <2.7 g/cm³. In this case, the fiber composite component is lighter than a fiber composite component of an identical shape made of an aluminum alloy while having comparable strength.

Other embodiments of the fiber composite component are apparent from the dependent claims referring to method claim 1.

According to the invention, a matrix composite material having a support structure is used to produce an aircraft cabin interior, in particular a tabletop, the matrix composite material being made of cut fibers, a resin, and a flame retardant, the support structure being made of a dimensionally stable fiber composite and/or a metal profile, the matrix composite material together with the support structure being introduced into a component mold and cured to form the fiber composite component, the support structure being at least partially bonded with the matrix composite material. Other embodiments of the use are apparent from the dependent claims referring to method claim 1 and to device claim 13.

Hereinafter, preferred embodiments of the invention will be explained in more detail with reference to the accompanying drawings.

FIG. 1 shows a side view of a first embodiment of a tabletop of an aircraft table;

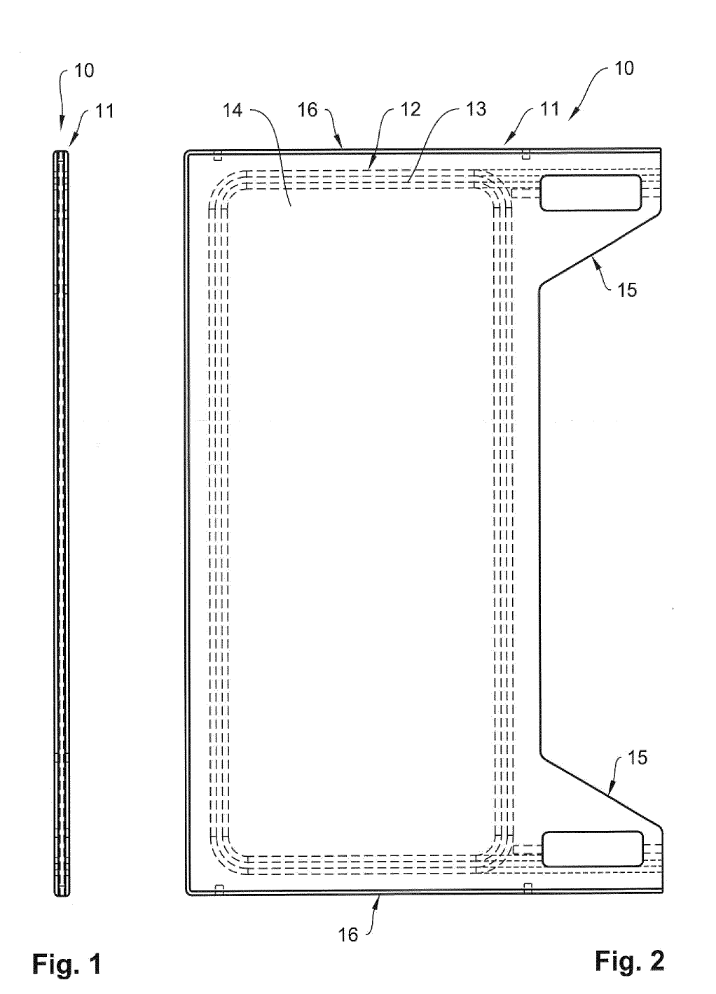

FIG. 2 shows a top view of the tabletop;

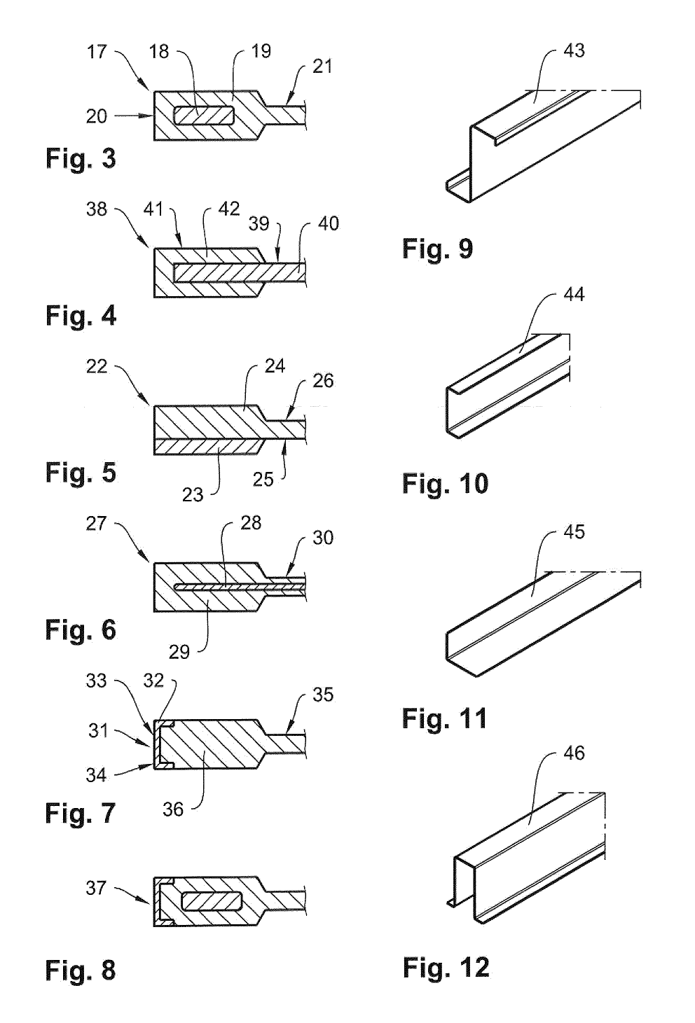

FIG. 3 shows a partial section view of a second embodiment of a tabletop;

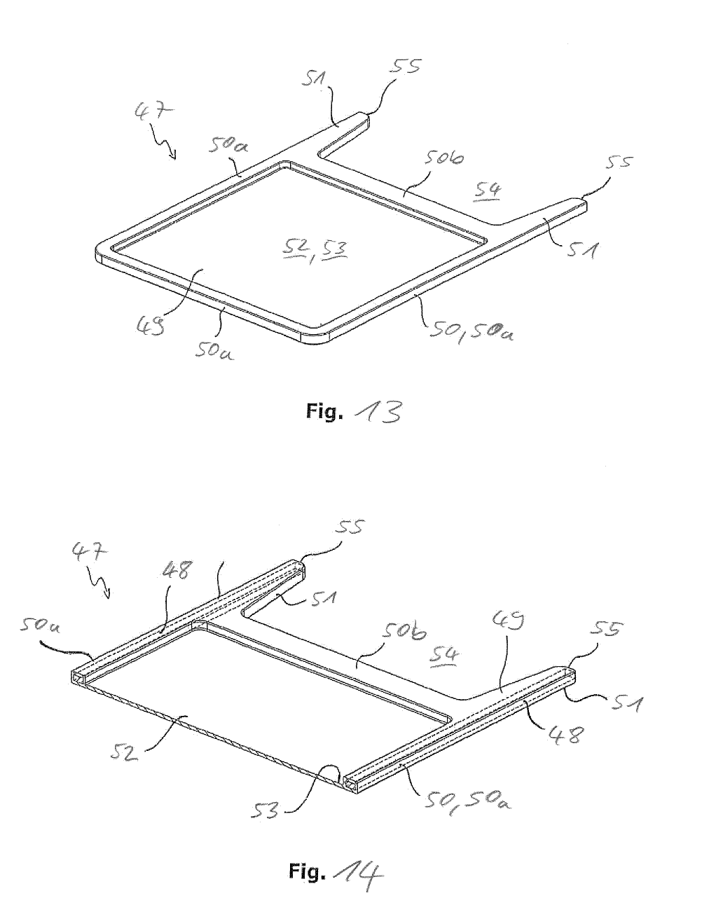

FIG. 4 shows a partial section view of a third embodiment of a tabletop;

FIG. 5 shows a partial section view of a fourth embodiment of a tabletop;

FIG. 6 shows a partial section view of a fifth embodiment of a tabletop;

FIG. 7 shows a partial section view of a sixth embodiment of a tabletop;

FIG. 8 shows a partial section view of a seventh embodiment of a tabletop;

FIG. 9 shows a perspective view of a first embodiment of a metal profile;

FIG. 10 shows a perspective view of a second embodiment of a metal profile;

FIG. 11 shows a perspective view of a third embodiment of a metal profile;

FIG. 12 shows a perspective view of a fourth embodiment of a metal profile;

FIG. 13 shows a perspective view of an eighth embodiment of a tabletop;

FIG. 14 shows a perspective view of the eighth embodiment of the tabletop.

A combined view of FIGS. 1 and 2 shows a tabletop 10 of an aircraft cabin interior, said tabletop 10 being made of a fiber composite component 11. The fiber composite component 11 has a support structure 12 formed by a dimensionally stable fiber composite 13 made of carbon fibers, which are coated with pyrolytic carbon and illustrated merely in outlines. A matrix composite material 14, which is made of cut fibers or carbon cut fibers (not illustrated), a cured resin, and a flame retardant, completely surrounds the fiber composite 13, the fiber composite 13 thus being located on the inside of the tabletop 10. In particular, the fiber composite component 11 has been formed by disposing the dimensionally stable fiber composite 13 in a component mold (not illustrated) together with the matrix composite material 14 and by subsequently curing the matrix composite material within the component mold. The support structure 12 is substantially configured in such a manner that a load condition of the fiber composite component 11 can be accommodated. For instance, the tabletop 10 has two fins 15 at which it can be inserted into a guide (not illustrated) of a galley and be slid into or pulled out of the guide along side edges 16.

FIGS. 3 to 9 show partial section views of different embodiments of tabletops in the area of a side edge. FIG. 3 shows a fiber composite component 17 having a fiber composite 18 within a cured matrix composite material 19. The matrix composite material 19 completely surrounds the fiber composite 18 and forms a side edge 20 and a tabletop 21.

FIG. 4 shows a fiber composite component 38 in which a plate 39 made of a matrix composite material 40 is formed, the plate 39 being inserted into an edge profile 41, the edge profile 41 being made of a fiber composite 42 which is bonded with the plate 39.

FIG. 5 shows a fiber composite component 22 having a fiber composite 23 and a matrix composite material 24, the fiber composite 23 being connected to the matrix composite material 24 in sections only and disposed on an underside 25 of a tabletop 26.

FIG. 6 shows a fiber composite component 27 which differs from the fiber composite component of FIG. 3 in that a dimensionally stable fiber composite 28 is plate-shaped and extends substantially within a matrix composite material 29 across an entire surface of a tabletop 30.

FIG. 7 shows a fiber composite component 31 having a U-shaped metal profile 32 which forms a support structure 33 and which is bonded with a matrix composite material 36 along side edges 34 of a tabletop 35.

FIG. 8 shows a fiber composite component 37 which combines the support structure illustrated in FIG. 3 with the support structure in FIG. 7.

FIGS. 9 to 12 show metal profiles 43 to 46, respectively, which can form a support structure. In principle, profiles made of a fiber composite can be used instead of the metal profiles 43 to 46.

In FIGS. 13 and 14, a part of an insertable or folding aircraft table, in particular a tabletop 47, is shown. The tabletop 47 has a table surface 52 which is limited by a frame 50. The frame 50 further comprises two frame protrusions 51 which serve to connect the tabletop 47 to an inserting or folding mechanism of the insertable or folding aircraft table.

The tabletop 52 is preferably rectangular and has a flat or plane surface. It is also possible that the tabletop 47 has recesses, i.e. areas of reduced wall thickness of the table surface, or through-holes in the area of the tabletop 52. Recesses or through-holes of this kind may serve as cup holders, for example.

As is clearly visible in FIG. 14, the table surface 52 is sunk or lowered in relation to the frame 50. Thus, the table surface 52 has a reduced wall thickness compared to the frame 50. It is preferably envisaged that an underside of the table surface 52 is flush with an underside of the frame 50. Overall, the entire tabletop 47 thus has a plane underside. A lowered portion 53 merely shows on the upper side of the tabletop 47, the lowered portion 53 being formed by the lowered table surface 52.

A cutout 54 is provided between the frame protrusions 51. Said cutout 54 serves in particular to offer freedom of movement for an inserting or folding mechanism. At the same time, the cutout 54 allows sufficient free space to remain below the insertable or folding table or tabletop 47 in the inserted or folded state, such as for a newspaper holder on a backrest of an aircraft seat.

For the sake of stability, it is envisaged that the frame protrusions 51 taper toward their free ends 55. The outer edge of the frame protrusions 51 aligns with the outer edge of the frame 50, resulting in a straight or plane side surface of the tabletop 47. The cutout 54 has a substantially trapezoidal contour, the cutout 54 being broader between the free ends 55 of the frame protrusions 51 than along the frame 50.

The frame 50 comprises four frame sections 50a, 50b, the frame section 50b connecting the frame protrusions 51 having a larger web width than the free other frame sections 50. This increases the stability of the tabletop 47.

The tabletop 47 comprises an inner support structure 48, which is indicated by dashed lines in FIG. 14. The inner support structure 48 is provided with a matrix composite material 49, which forms the complex outer shape of the tabletop 47. In particular, the support structure 48 comprises rods, tubes or profiles which are made of a fiber composite material reinforced by endless fibers, in particular a carbon fiber composite material reinforced by endless fibers. As is clearly visible in FIG. 14, the rods of the support structure 48 extend along the free frame sections 50a as far as into the frame protrusions 51. The rods, tubes or profiles of the support structure 48 preferably have a rectangular crosssectional contour. The endless fibers preferably extend in the longitudinal direction of the rods, tubes or profiles of the support structure 48.

The matrix composite material 49 is formed by an SMC material. Said SMC material preferably comprises a carbon fiber composite material, the carbon fibers being embedded non-directionally in a polymer matrix as long fibers. The SMC material does not only completely envelop the support structure 48, but also forms the table surface 52 and the connecting frame section 50b. Moreover, the outer contour of the frame protrusions 51 is defined by the SMC material.

For example, the tabletop 47 of an aircraft table illustrated here by way of example is produced by a method that involves the following steps:

The support structure 48 is produced using a pultruding method, in particular by pultrusion, for example, or by wet winding or pre-preg lamination or vacuum infusion or another RTM method, from fiber-reinforced plastic or fiber composite materials. The fiber-reinforced plastic preferably comprises carbon fibers which are embedded in a matrix made of an epoxy resin, a vinyl ester resin, or a fire-resistant phenolic resin. The carbon fibers are endless fibers and can be oriented in a common main orientation direction.

The support structure 48 can be produced in one piece or comprise multiple pieces which are at least temporarily connected to one another by corresponding joining techniques. In particular, the support structure 48 can be formed by multiple rods, tubes or profiles which are glued together. The support structure 48 is pre-cured and, in a next step, is either embedded into the SMC material or placed into a component mold, which is preferably already filled or lined with an SMC material.

The support structure 48 can be embedded into the SMC material by placing the support structure 48 on a layer of the SMC materials, the support structure 48 covering only part of the layer of the SMC material. An overlapping part of the SMC materials can be folded over and laid on the support structure 48. Preferably, the support structure 48 is thus sandwiched between two portions of the layer of the SMC material and, together with the SMC material, forms a preform.

The preform is subsequently placed in a pressing tool. Alternatively, it may also be envisaged for the preform to be formed in the pressing tool itself. For this purpose, a layer of the SMC material can be placed into a tool half of the pressing tool, a portion of the layer extending beyond the tool half. The support structure 48 is placed into the pressing tool on top of the layer of the SMC material. The portion of the layer sticking out of the tool half is then folded over and laid on the support structure 48 so that the preform forms directly in the component mold.

In general, the support structure 48 can be embedded into multiple layers of the SMC material. In particular, the support structure 48 can be placed on a first layer of the SMC material, and an independent second layer of the SMC material can be placed on the first layer and on the support structure 48 so that the support structure 48 is covered by a separate layer of the SMC material on either side.

It may be advantageous if the component mold has holding devices for positioning the support structure 48. The SMC material can have glass fibers, carbon fibers, and/or aramid fibers which are embedded in a polymer matrix. The polymer matrix can comprise epoxy resin and/or vinyl ester resin and/or phenolic resin.

Preferably, the SMC material is fire-resistant pursuant to the aviation regulations. For example, the SMC material can have a polymer matrix which is filled with flame-retardant aluminum trihydroxide. In its raw state, the aluminum trihydroxide is preferably a powder and is admixed to the polymer matrix. The polymer matrix of the SMC material can also contain epoxy resin and/or vinyl ester resin and/or phenolic resin.

By embedding the support structure into the SMC material, a preform is formed, which is compressed in a pressing tool. The pressing tool preferably has a tool shape that corresponds to a negative shape of the component to be produced.

For example, compression takes place at a pressure between 80 bar and 150 bar and at a temperature between 125° C. and 150° C. in the pressing tool. The SMC material fills the mold geometry of the pressing tool and structurally bonds with the pre-cured support structure 48. Thus, a bonded connection is formed between the support structure 48 and the matrix composite material 49. Hence, the finished aircraft component has a monolithic sandwich structure which has high mechanical stability owing to the embedded support structure 48. The support structure 48 mainly serves to transmit loads and to absorb mechanical forces, whereas the matrix composite material 49, which is formed by an SMC material, presents the complex outer component contour.

The compressed component preferably cures after few minutes, in particular within a period of 1 minute to 10 minutes, in the hot pressing tool.

Once the curing time has elapsed, the finished aircraft component, in particular the tabletop 47 described above, is removed from the hot pressing tool.

1. A method for producing a fiber composite component (11, 17, 22, 27, 31, 37, 38), for an aircraft, in particular for an aircraft cabin interior, a tabletop (10, 21, 26, 30, 35, 39, 47) or the like, the fiber composite component being formed from a matrix composite material (14, 19, 24, 29, 36, 40, 49) and a support structure (12, 33, 48),
characterized in that
the matrix composite material is formed from cut fibers, a curable resin, and a flame retardant, the support structure being formed from a dimensionally stable fiber composite (13, 18, 23, 42) and/or from a metal profile (32, 43, 44, 45, 46), the matrix composite material together with the support structure being introduced into a component mold and cured to form the fiber composite component, the support structure being at least partially bonded with the matrix composite material.

2. The method according to claim 1,
characterized in that
the fiber composite (13, 18, 23, 42) is formed from textile fibers and/or unidirectional fibers.

3. The method according to claim 1,
characterized in that
the fiber composite (13, 18, 23, 42) is formed as a spatially oriented support structure (12, 33, 48) of the fiber composite component (11, 17, 22, 27, 31, 37, 38) which is adapted to a load condition of the fiber composite component.

4. The method according to claim 1,
characterized in that
the fiber composite (13, 18, 23, 42) is formed from carbon fibers, the carbon fibers being coated with pyrolytic carbon fibers so as to form the fiber composite.

5. The method according to claim 4,
characterized in that
the pyrolytic carbon is deposited onto the carbon fibers from the vapor phase.

6. The method according to claim 1,
characterized in that
the cut fibers are carbon fibers.

7. The method according to claim 4,
characterized in that
the fiber composite component (11, 17, 22, 27, 31, 37, 38) is formed in such a manner that it has a carbon fiber content of >35% by volume, preferably >50% by volume.

8. The method according to claim 4,
characterized in that
the fiber composite component (11, 17, 22, 27, 31, 37, 38) is formed in such a manner that the carbon fibers are distributed heterogeneously within the fiber composite component.

9. The method according to claim 1,
characterized in that
the matrix composite material (14, 19, 24, 29, 36, 40, 49) is a semi-finished fiber matrix product, in particular a sheet molding compound (SMC) or a bulk molding compound (BMC).

10. The method according to claim 1,
characterized in that
the matrix composite material (14, 19, 24, 29, 36, 40, 49) is compressed with the support structure (12, 33, 48) in the component mold at a pressure of 80 bar and 150 bar, in particular between 90 bar and 110 bar, and at a temperature between 125° C. and 150° C., in particular between 130° C. and 140° C.

11. The method according to claim 1,
characterized in that
the flame retardant is aluminum hydroxide.

12. The method according to claim 1,
characterized in that
the matrix composite material (14, 19, 24, 29, 36, 40, 49) contains at least 40 w %, in particular at least 50 w %, in particular at least 60 w %, in particular at least 70 w % of aluminum trihydroxide.

13. The method according to claim 1,
characterized in that
the fiber composite (13, 18, 23, 42) is disposed in a premold and is pre-stabilized, preferably pre-cured, by pressing.

14. The method according to claim 1,
characterized in that
the support structure (12, 48) is introduced into the component mold in such a manner that the matrix composite material (14, 19, 29, 49) completely surrounds the support structure.

15. The method according to claim 1,
characterized in that
the support structure (12, 33, 48) is formed in one piece or in multiple pieces, the support structure at least in sections forming a frame (50) which defines a frame inner surface, the frame inner surface being filled by the matrix composite material (14, 19, 29, 49).

16. A fiber composite component (11, 17, 22, 27, 31, 37, 38) for an aircraft, in particular for an aircraft cabin interior, a tabletop (10, 21, 26, 30, 35, 39, 47) or the like, the fiber composite component being made of a matrix composite material (14, 19, 24, 29, 36, 40, 49) and a support structure (12, 33, 48),
characterized in that
the matrix composite material is made of cut fibers, a resin, and a flame retardant, the support structure being made of a dimensionally stable fiber composite (13, 18, 23, 42) and/or of a metal profile (32, 43, 44, 45, 46), the matrix composite material together with the support structure having been introduced into a component mold and cured to form the fiber composite component, the support structure being at least partially bonded with the matrix composite material.

17. The fiber composite component according to claim 16,
characterized in that
the fiber composite component (11, 17, 22, 27, 31, 37, 38) has a density of <2.7 g/cm³.

18. A use of a matrix composite material (14, 19, 24, 29, 36, 40, 49) having a support structure (12, 33, 48), for producing an aircraft cabin interior, in particular a tabletop (10, 21, 26, 30, 35, 39, 47), wherein the matrix composite material is made of cut fibers, a resin, and a flame retardant, the support structure being made of a dimensionally stable fiber composite (13, 18, 23, 42) and/or of a metal profile (32, 43, 44, 45, 46), the matrix composite material together with the support structure being introduced into a component mold and cured to form the fiber composite component, the support structure being at least partially bonded with the matrix composite material.
